(19) United States
(12) Patent Application Publication
(10) Pub. No.: US 2012/0162982 A1
(43) Pub. Date: Jun. 28, 2012

(54) LED LAMP

(75) Inventors: HUA WANG, Shenzhen City (CN); GUANG YU, Shenzhen City (CN)

(73) Assignees: FOXCONN TECHNOLOGY CO., LTD., Tu-Cheng (TW); FU ZHUN PRECISION INDUSTRY (SHEN ZHEN) CO., LTD., Shenzhen City (CN)

(21) Appl. No.: 13/075,188

(22) Filed: Mar. 30, 2011

(30) Foreign Application Priority Data
Dec. 28, 2010 (CN) 201010614723.2

(51) Int. Cl. F21V 7/00; F21S 4/00

(52) U.S. Cl. 362/235; 362/249.02

(57) ABSTRACT

An LED lamp includes a metallic body, a light source, a transparent cover, and a sealing assembly. The body includes a first surface. The light source is arranged on the first surface. Two sideboards are formed separately on the first surface at two sides of the body. A cavity is formed on a surface of each sideboard away from the first surface. Sealant is put in the cavity. A top seal bar is pressed into the cavity. The sealing assembly is arranged on the surface of the cover facing the sideboards. Interstices between the cover and the sideboards are filled with the sealant. Two side seals seal two opposite lateral ends of the body.

### BACKGROUND

1. Technical Field

The disclosure relates to illumination devices, and particularly to an LED lamp.

2. Description of the Related Art

Light emitting diodes' (LEDs) many advantages, such as high luminosity, low operational voltage, low power consumption, compatibility with integrated circuits, easy driving, long term reliability, and environmental friendliness have promoted their wide use as a light source. Now, LEDs are commonly applied in environmental lighting.

However, thermal dissipation and waterproofing qualities of LEDs are lacking in environmentally challenging applications.

Therefore, it is desirable to provide an LED lamp with good thermal dissipation and waterproof design.

### BRIEF DESCRIPTION OF THE DRAWINGS

Many aspects of the disclosure can be better understood with reference to the drawings. The components in the drawings are not necessarily drawn to scale, the emphasis instead being placed upon clearly illustrating the principles of the present LED lamp. Moreover, in the drawings, like reference numerals designate corresponding parts throughout the views.

FIG. 1 is a schematic view of an LED lamp in accordance with a first embodiment.

FIG. 2 is a cross section view of the LED lamp of FIG. 1.

FIG. 3 is an exploded view of the LED lamp of FIG. 1.

### DETAILED DESCRIPTION

Embodiments of an LED lamp as disclosed are described in detail here with reference to the drawings.

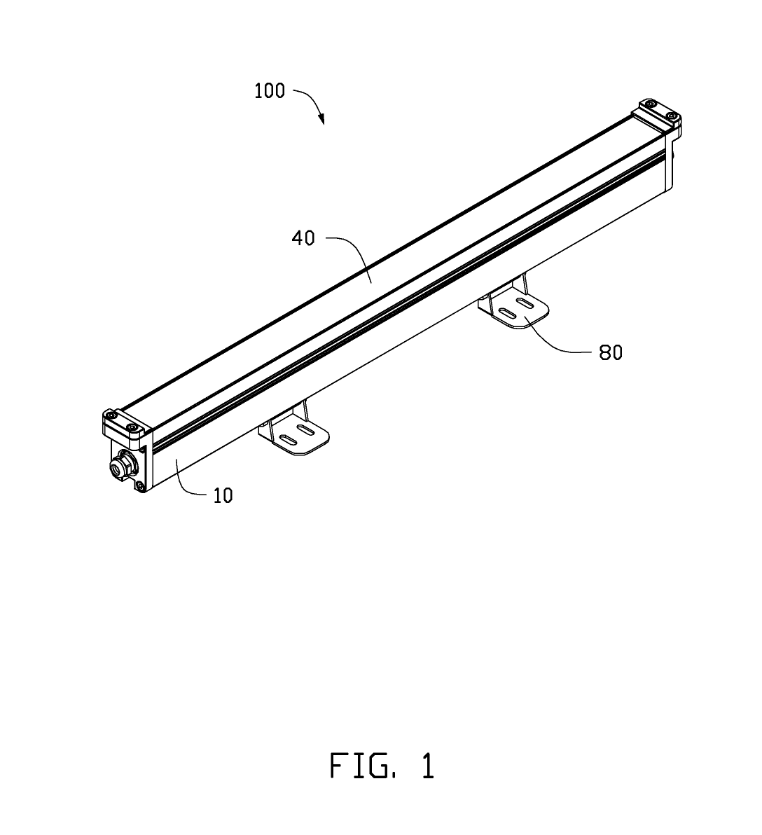

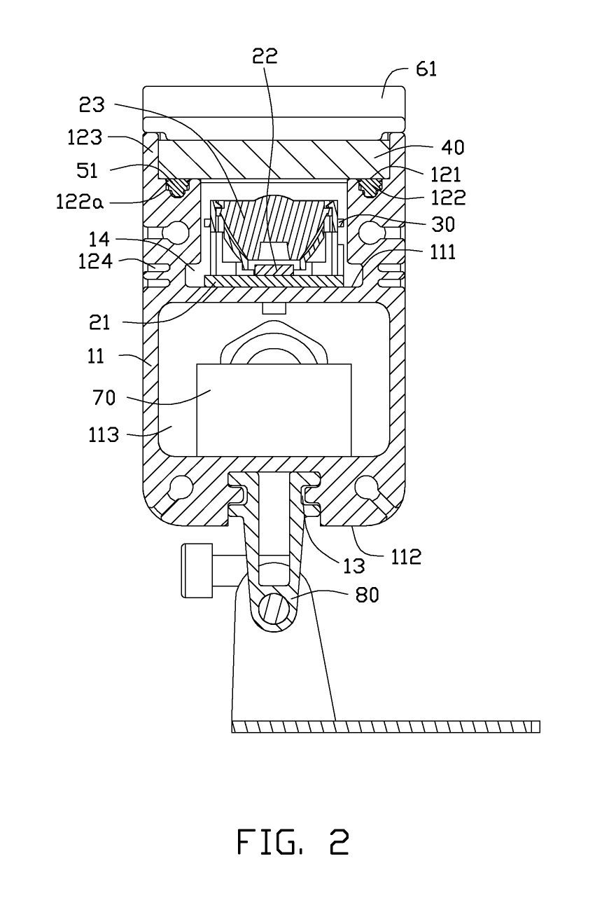

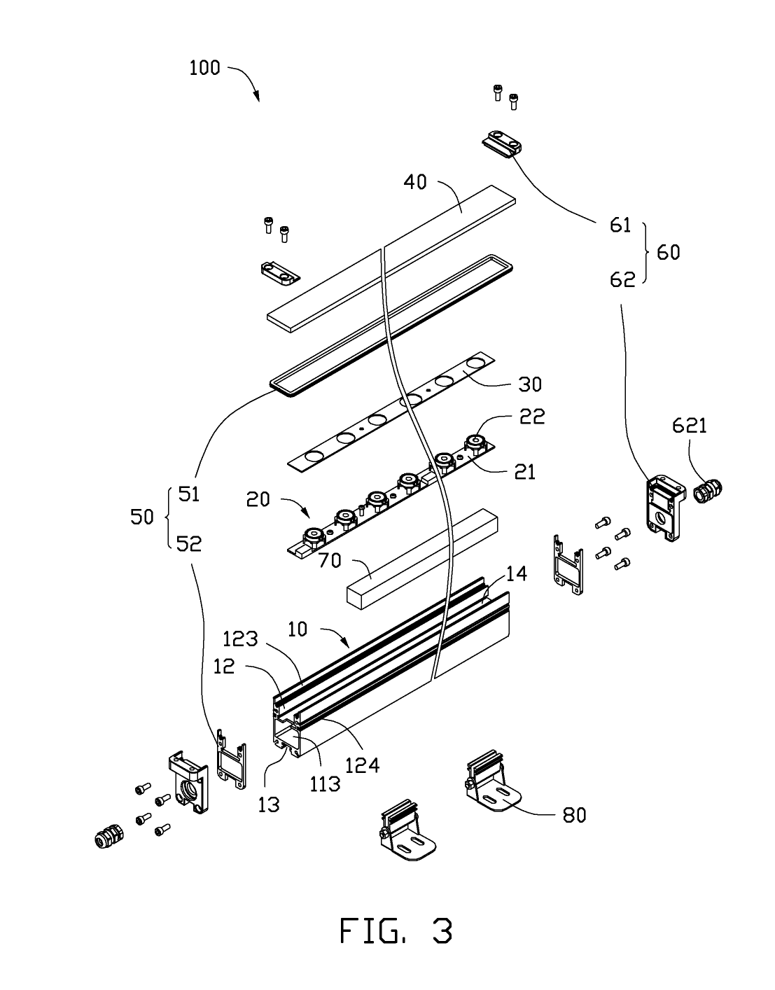

Referring to FIGS. 1 to 3, an LED lamp 100 in accordance with a first embodiment includes a body 10, a light source 20, a reflection plate 30, a transparent cover 40, a sealing assembly 50, a fixing cover 60, a driving circuit 70, and two connecting pieces 80.

The body 10 includes a tube 11, two sideboards 12, a connecting groove 13, and a receiving cavity 14. The body 10 is formed in a piece using material with excellent thermal conduction. More specifically, the body 10 is formed by aluminum extrusion. The tube 11, as a rectangular tube, includes a first surface 111, a second surface 112 opposite to the first surface 111, and a receiving chamber 113 between the first surface 111 and the second surface 112.

The two sideboards 12 are formed on the first surface 111 of the tube 11 and extend along two long sides of the first surface 111 of the tube 11. The two sideboards 12 are perpendicular to the first surface 111 of the tube 11. In this embodiment, the width of the body 10, which is equal to a distance between the two sideboards 12, is 34 mm. The two sideboards 12 include a top surface 121 and two cavities 122, 122a defined on the top surface 121. Each cavity 122 (122a) has an opening facing away from the tube 11. The cavity 122 (122a) is trapezoidal. The receiving cavity 14 is defined by the first surface 111 of the tube 11 and the two sideboards 12.

An extending portion 123 is defined on the top surface 121 of each sideboard 12 on the side away from the other sideboard 12. The extending portions 123 respectively extend along the two long sides of the top surface 121 of the sideboards 12 away from the top surface 121. The outsides of the two sideboards 12 are formed with a plurality of heat dissipation structures 124. In this embodiment, the heat dissipation structures 124 are finned heat sinks. The connecting groove 13 is formed in the second surface 112.

The light source 20 attached on the first surface 111 of the tube 11 includes a substrate 21, a plurality of LEDs 22 arranged on a surface of the substrate 21, and a plurality of lenses 23 covered on the LEDs 22.

The reflection plate 30 is mounted on the substrate 21. Openings (not labeled) are defined in the reflection plate 30 respectively aligned with the LEDs 22. Any light from the LEDs 22 reflected back towards the LEDs can be reflected out by the reflection plate 30.

The transparent cover 40 is mounted on the body 10 and covers the light source 20 and the reflection plate 30. The transparent cover 40 is made of transparent materials. Because the transparent cover 40 can utilize different materials having different colors, the color of emitted light from the LEDs 22 can be selected according to application and preference.

Width of the transparent cover 40 matches the distance between the two extending portions 123. Length of the transparent cover 40 is equal to the length of the body 10. Thus, the transparent cover 40 is arranged on the top surface 121 without interstice between the top surface 121 and the transparent cover 40.

The sealing assembly 50 includes a top seal bar 51 and two side seals 52. The top seal bar 51 is arranged between the transparent cover 40 and the top surface 121. The transparent cover 40 presses the top seal bar 51 into the cavities 122, 122a, and the interstices around the top seal bar 50 can be filled with sealant.

In this embodiment, a sealant is put into the cavities 122, 122a first. The top seal bar 51 is then pressed into the cavities 122, 122a. The side seals 52 are arranged at two ends of the body 10. The seal assembly 50 prevents penetration of moisture into the body 10 and protects the LEDs 22.

The fixing cover 60 includes two top covers 61 and two side covers 62. The two side covers 62 are arranged at two ends of the body 10. The two side covers 62 connect to the body 10, and the side seals 52 are located between and waterproof the joints between the two side covers 62 and the body 10. A waterproof interface 621 is arranged on the two side covers 62. The top covers 61 are fixed on the side covers 62 with screws. Thus, the transparent cover 40 is fixed between the two extending portions 123.

The driving circuit 70 is arranged inside the receiving chamber 113. The driving circuit 70 drives the lighting source 20 to emit light. The driving circuit 70 connects to an external power source through the waterproof interface 621.

The two connecting pieces 80 in this embodiment are mounted on the connecting groove 13. The quantity of the connecting pieces can exceed two. The connecting pieces 80 slide in the connecting groove 13. The connecting pieces 80 are used for fixing the LED lamp 100 on the wall.

While the disclosure has been described by way of example and in terms of exemplary embodiment, it is to be understood that the disclosure is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An LED lamp, comprising:
a metallic body, a light source, a transparent cover, and a sealing assembly, wherein the body has a first surface with the light source arranged thereon, two sides of the body on the first surface respectively forms a sideboard, a surface of each sideboard away from the first surface forms a cavity, a sealant is arranged in the cavity, two lateral sides of the transparent cover is arranged on the surfaces of the two sideboards, the sealing assembly is arranged on a surface of the transparent cover facing the sideboards and sealed with the sealant in the cavity.

2. The LED lamp of claim 1, wherein the sealant is inside the cavity, the sealing assembly is pressed into the cavity by the transparent cover, and interstices between the transparent cover and the sideboards are filled with the sealant.

3. The LED lamp of claim 1, wherein the body is formed in one piece.

4. The LED lamp of claim 1, wherein heat dissipation structures are formed on outside surfaces of the two sideboards.

5. The LED lamp of claim 1, wherein the body includes a tube with a second surface opposite to the first surface.

6. The LED lamp of claim 5, wherein the two sideboards extends along two long sides of the first surface of the tube, and an extending direction of the cavity and the sealing assembly is the same with the sideboards.

7. The LED lamp of claim 5, further including a driving circuit arranged inside the tube.

8. The LED lamp of claim 5, wherein a connecting groove is defined on the second surface including a connecting piece which is fastened into the connecting groove and slideably connected to the body.

9. The LED lamp of claim 1, wherein the light source includes a substrate, an LED, and a reflection plate, the reflection plate is mounted on the substrate, and at least an opening is defined in the reflection plate for receiving the LED.

10. The LED lamp of claim 1, further including two side covers sealing two ends of the body, wherein the sealing assembly comprises two side seals between the side covers and two ends of the body.

11. The LED lamp of claim 1, wherein the body is formed by aluminum extrusion.
